(19) United States
(12) Patent Application Publication
(10) Pub. No.: US 2017/0299901 A1
(43) Pub. Date: Oct. 19, 2017

(54) OPTICAL TRANSMITTER AND OPTICAL TRANSCEIVER

(71) Applicant: NEC Corporation, Tokyo (JP)

(72) Inventor: Hirokazu KOMATSU, Tokyo (JP)

(73) Assignee: NEC Corporation, Tokyo (JP)

(21) Appl. No.: 15/515,941

(22) PCT Filed: Oct. 5, 2015
(86) PCT No.: PCT/JP2015/005057

§ 371 Date: Mar. 30, 2017

(30) Foreign Application Priority Data
Oct. 8, 2014 (JP) 2014-206950

(51) Int. Cl. G02F 1/01; G01N 25/00; H04B 10/572; H04J 14/02

(52) U.S. Cl. CPC G02F 1/0121; H04B 10/572; G01N 25/00; H04J 14/02

(57) ABSTRACT

In order to provide an optical transmitter in which a temperature sensor does not need to be separately provided, and further, size reduction can be made, in the present invention, a detection circuit detecting output fluctuation due to temperature dependency of a transmission driver is provided in an optical transmitter including at least one of the transmission driver.

### TECHNICAL FIELD

The present invention relates to an optical transmitter and an optical transceiver that include a temperature monitoring function.

### BACKGROUND ART

In an optical transceiver, accompanying size reduction and speeding-up, it has become important to monitor a temperature of a device. Because of highly dense mounting, a temperature monitoring method using discrete components, however, causes a problem of monitoring accuracy due to restriction on component arrangement. Particularly concerning an active device accompanied by heat generation of a driver and the like constituting a transmission unit, there is no case of arranging a temperature sensor internally, and it is desired to implement a temperature monitoring function that does not need an external component.

In an optical transceiver at a 100 Gbps class, as a pluggable transceiver, size reduction has progressed by standardization such as centum gigabit form factor pluggable (CFP), CFP2, and CFP4. In long-distance application, a coherent optical communication technique that uses, as a modulation method, phase modulation such as binary phase-shift keying (BPSK), quadrature phase shift keying (QPSK), and 16 quadrature amplitude modulation (16 QAM) is generally used, and a transmission unit is implemented by a Mach-Zehnder modulator.

However, in order to drive a Mach-Zehnder modulator whose material is lithium niobate, amplitude of 6 to 7 Vpp is generally required, and even in the case of a modulator whose material is indium phosphide, necessary amplitude is generally 5 Vpp. Further, a four-channel high-output amplitude driver that drives four Mach-Zehnder modulators adapted to orthogonal modulation and dual polarization is necessary, and occupies a large proportion of electric power consumption in a transceiver. In addition to this, for adaptation to dense wavelength division multiplexing (DWDM) communication, active devices such as a wavelength-variable light source and a coherent receiver are also mounted in an optical transceiver. Further, in CFP, there is a case of additionally housing a digital signal processor (DSP) that performs signal processing of transmission and reception.

In a small transceiver, these active devices need to be mounted highly densely, and in order to monitor product degradation due to heat generation, it has been examined to provide a temperature monitoring function for each device. It is, however, general that a temperature monitoring function is not incorporated in a transimpedance amplifier incorporated in a modulator-driving driver and a receiver, and it is general that a temperature sensor is mounted externally.

FIG. 6 is a block diagram of a long-distance coherent optical transceiver, represented by CFP2, in which a high-speed signal-processing DSP is not incorporated. A driver 41, a coherent receiver 42, and a wavelength-variable light source 43 are active devices accompanied by main heat generation, and it is desired to monitor temperatures of these active devices.

A temperature sensor 46 is intended to monitor a temperature of the driver 41, and is configured to make notification to an outside via a controller 45. A pluggable transceiver has a configuration with input and output terminals being arranged in one direction of a short edge of a case body, a transmission unit and a reception unit are arranged to neighbor each other, and particularly there is a tendency that a mounting density of wirings and components increases in an electric interface unit for interfacing with an outside.

Further, the driver 41 includes a function of amplifying four-channel high-speed signals to high-output amplitude, and consumes a large amount of electricity so that a heat-radiation heat sink needs to be installed on a back surface of the driver. In addition to this, since a broadband signal needs to be amplified with good power efficiency, a nearby external bias tee is necessary for the driver output, and for such a reason, a mounting space near the device is greatly restricted.

Under such a restriction, even when the temperature sensor 46 can be arranged, it is difficult to appropriately make thermal separation from other active devices, and a distance between the driver including four channels and the temperature sensor becomes uneven to cause a problem that accuracy in temperature monitoring is deteriorated.

Thus, temperature monitoring that uses the external temperature sensor not only causes increase in the number of components, contrary to high-density mounting, but also has a problem in accuracy because of difficulty in arranging the temperature sensor near a heating element, heat flowing around from other devices, and the like.

PTL 1 describes the following semiconductor optical element. In the case of a semiconductor laser in which electro-absorption modulators are integrated, a region where a current-voltage property can be measured is provided near a laser unit that most generates heat in the element. Since the current-voltage property fluctuates depending on a temperature of an element active layer unit, an element temperature is detected by reading a voltage value when a certain constant current is supplied.

According to PTL 2, temperature compensation control of the laser module and an integrated circuit (IC) for the driver driving this module is simultaneously performed in parallel, using temperature sensing element information used in reception-side control.

PTL 3 describes the following optical transmitter. A photodiode (PD) monitoring light of a laser diode is provided, and when a current value of the PD is constant, a voltage value of the PD becomes a linear function of a temperature, and for this reason, from this current value, a temperature inside a package is measured.

PTL 4 describes an optical transceiver that detects a voltage drop of a transmission-light-monitoring PD receiving monitoring light of transmission light, and on the basis of this voltage drop, measures a temperature inside a package.

### CITATION LIST

### Patent Literature

[PTL 1] Japanese Patent Application Laid-open Publication No. 2006-324801

[PTL 2] Japanese Patent Application Laid-open Publication No. 2007-019119

[PTL 3] Japanese Patent Application Laid-open Publication No. 2010-251646

[PTL 4] Japanese Patent Application Laid-open Publication No. 2011-165714

[PTL 5] Japanese Patent Application Laid-open Publication No. 2006-054272

### Non Patent Literature

[NPL 1] Craig Steinbeiser, Khiem Dinh, Anthony Chiu, Matt Coutant, Oleh Krutko, Mike Tessaro, “100 Gb/s Optical DP-QPSK using two Surface Mount Dual Channel Modulator Drivers” Compound Semiconductor Integrated Circuit Symposium (CSICS), 2012 IEEE pp. 1-4

[NPL 2] Hisao Shigematsu, Masaru Sato, Tatsuya Hirose, and Yuu Watanabe, “A 54-GHz distributed amplifier with 6-VPP output for a 40-Gb/s LiNbO₃ modulator driver” IEEE Journal of Solid-State Circuits Volume: 37, Issue: 9, pp 1100-1105

### SUMMARY OF INVENTION

### Technical Problem

In PTL 1, a region where a current-voltage property can be measured needs to be newly provided near the laser unit. This is equivalent to the matter that a temperature sensor is incorporated. Further, in PTL 2, a temperature sensing element (e.g., a thermistor) needs to be incorporated. Furthermore, in PTLs 3 and 4, a circuit for driving the PD is added so that a circuit size increases.

An object of the present invention is to provide an optical transmitter in which a temperature sensor does not need to be separately provided, and further, size reduction can be made.

### Solution to Problem

The present invention is an optical transmitter including at least one transmission driver, wherein a detection circuit detecting output fluctuation due to temperature dependency of the transmission driver is provided.

### Advantageous Effects of Invention

According to the present invention, it is possible to provide an optical transmitter in which a temperature sensor does not need to be separately provided, and further, size reduction can be made.

### BRIEF DESCRIPTION OF DRAWINGS

FIG. 1 is a diagram illustrating an optical transmitter according to a first example embodiment of the present invention.

FIG. 2 is a diagram illustrating an optical transceiver according to a second example embodiment of the present invention.

FIG. 3 is a diagram illustrating an optical transceiver according to a third example embodiment of the present invention.

FIG. 4 is a diagram illustrating an optical transceiver according to a fourth example embodiment of the present invention.

FIG. 5 is a diagram illustrating an optical transceiver according to a fifth example embodiment of the present invention.

FIG. 6 is a diagram illustrating an optical transceiver in the background art.

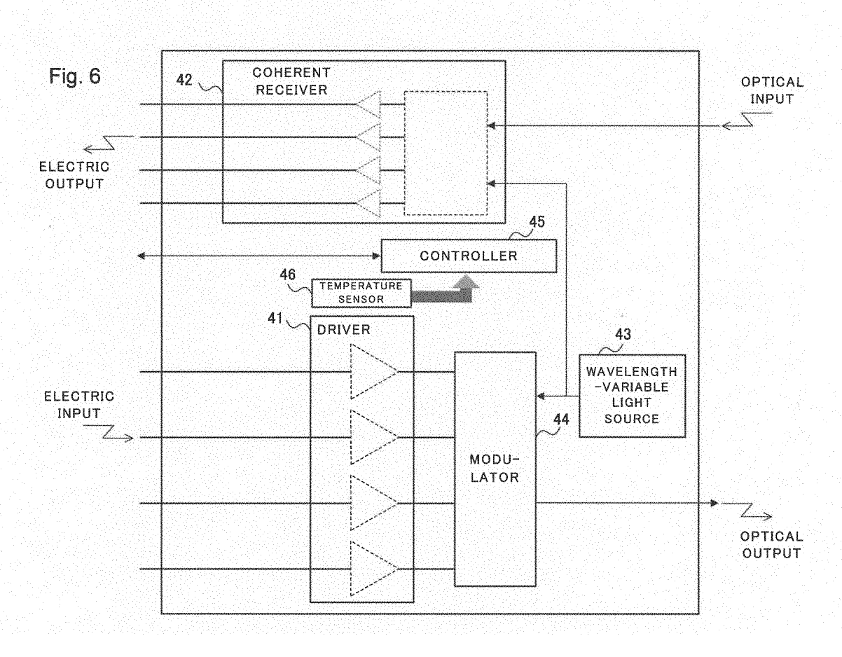

### DESCRIPTION OF EXAMPLE EMBODIMENTS

### 1st Example Embodiment

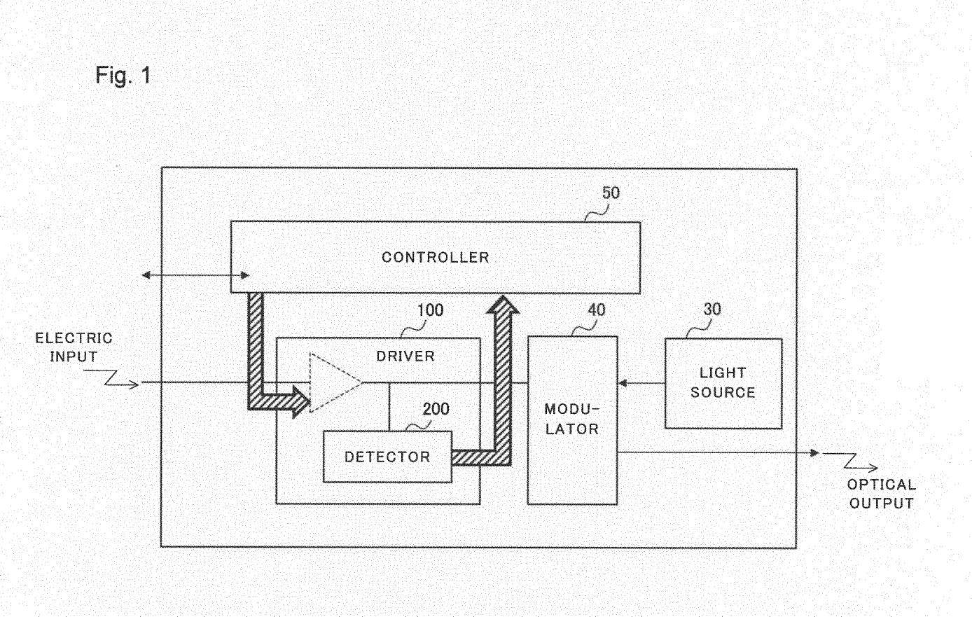

FIG. 1 is a diagram illustrating a configuration according to a first example embodiment of the present invention. This is an optical transmitter including a transmission driver 100. A detector 200 detecting output fluctuation due to temperature dependency of the driver 100 is provided. An electric input signal from a host side is amplified, and a signal suitable for a modulation format of the optical transmitter is output to a modulator 40. The detector 200 is provided at a driver output, and outputs to a controller 50 a signal proportional to output signal amplitude. An original role of the detector is to monitor driver output and perform malfunction detection or the like, and this role continues to be used without change, also in the present example embodiment.

At the modulator 40, light source output of a light source 30 is input, modulation is performed by a signal of the driver 100, and a signal is output from an optical output port. At the controller 50, a function of performing control and state monitoring of devices mounted inside the optical transmitter is provided, and bidirectional transmission and reception of signals is performed with the host side.

Output of the driver fluctuates depending on a temperature. For example, on the assumption that a field effect transistor (FET) is used as the driver, trans conductance gm of the FET generally has a temperature property of lowering at a high temperature. Further, under a condition that a voltage between a gate and a source of the FET is constant, a threshold voltage Vt has a temperature property, and in addition, a drain current has a temperature property. The output thus having the temperature properties is detected so that from the output, a temperature can be calculated backward. Further, as the detector, a detector originally incorporated in the transmission driver is used. Examples of the detector include an amplitude detector, a current detector, and the like. These originally include a function of detecting fluctuation in amplitude and a current and feeding the fluctuation back to the controller 50 so that the driver 100 is controlled to be in a normal range. In the present example embodiment, while this original function is made to work without change, the above-described temperature detection is performed. For this reason, a dedicated temperature sensor is unnecessary, size reduction can be made, and further, high accuracy can be attained. The directions of the arrows in FIG. 1 represent one example, and do not limit directions of signals between blocks.

### 2nd Example Embodiment

### Configuration of Example Embodiment

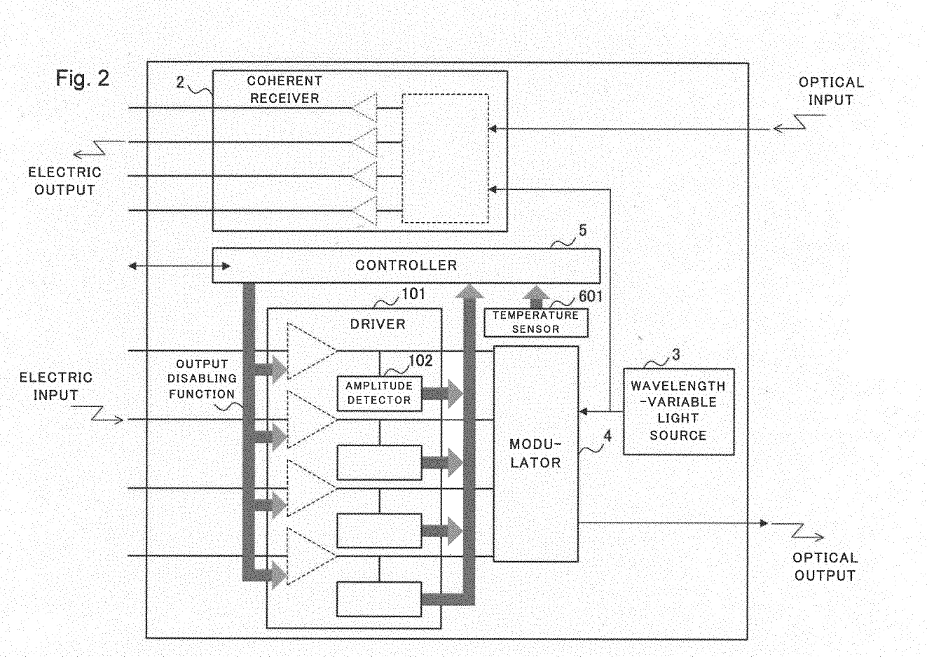

FIG. 2 is a block diagram illustrating a configuration of an optical transceiver according to a second example embodiment of the present invention.

A driver 101 is a modulator driver configured by four channels, and amplifies electric input signals from a host side, and outputs, to a modulator 4, signals suitable for a modulation format of a transmitter. An amplitude detector 102 is provided at an output of each channel of the driver 101, and outputs to the controller 5 a signal proportional to output signal amplitude. An original role of the amplitude detection function is to monitor amplitude of driver output and perform malfunction detection or the like, and this role continues to be used without change, also in the present example embodiment.

At the modulator 4, light source output of a wavelength-variable light source 3 is input, and modulation is performed by signals of the driver 101, and a signal is output from an optical output port. A coherent receiver 2 performs coherent wave detection on a signal from an optical input port, using single oscillation light from the wavelength-variable light source 3 to convert the signal into electric signals, and outputs the electric signals to the host side. At the controller 5, a function of performing control and state monitoring of devices mounted inside the transceiver is provided, and bidirectional transmission and reception of signals is performed with the host side.

A temperature sensor 601 is a temperature sensor for monitoring an internal temperature of the transceiver, and includes a function of notifying the controller 5 of a temperature monitored value.

### Description of Operation in Example Embodiment

With reference to FIG. 2, operation of the present example embodiment is described.

The driver 101 in FIG. 2 is adapted to a broadband and to high-output amplitude, and includes at an output stage a widely-used configuration of a cascode type of distributed constant amplifier for which a high electron mobility transistor (HEMT: a high electron mobility field-effect transistor) process is used as in NPLs 1 and 2. Meanwhile, since mobility of electrons that are carriers has a property of lowering at a high temperature, transconductance gm of the FET has temperature dependency, and for this reason, lowers at a high temperature as well. Since gain of the driver is in proportional to gm, the driver has a property that the gain similarly lowers at a high temperature. Under a condition that input signal amplitude is constant, when a temperature of a case of the transceiver changes, and temperature fluctuation occurs at the FET of the driver, amplitude of driver output fluctuates. In the present example embodiment, attention is focused on the matter that the amplitude detector has a temperature property, this temperature property is used in temperature measurement of the driver.

When a relation between output amplitude and a temperature of the driver is approximated by a polynomial whose variable is a temperature, “A(T)=Aₒ+A₁T+A₂T²+ . . . ” is established. Here, A(T) is output amplitude of the driver, Aₒ is a temperature coefficient at 0° C., A₁ is a primary temperature coefficient, A₂ is a secondary temperature coefficient, and T is a temperature of the driver. This relation between amplitude and a temperature means that a temperature property can be measured by only the driver. A curve of output voltage amplitude in relation to a temperature is measured, and fitting between this curve and the approximate equation A(T) is made to determine Aₒ, A₁, A₂, . . . , in advance. When high accuracy is necessary, the fitting is made up to a coefficient of high order.

Next, on the assumption that an amplitude detected value is V_{det}, and output amplitude is A(T), a signal detected by the amplitude detector 102 is expressed by V_{det}=a+bA(T). Here, a is an offset of a detection circuit, and b is gain of the detection circuit. A signal having a temperature property of V_{det}=a+b(Aₒ+A₁T+A₂T²+ . . . ) is input to the controller 5 so that a driver temperature T can be calculated since V_{det}, a, b, Aₒ, A₁, A₂, . . . are known.

Further, as the driver used in the present example embodiment, the four channels are mounted. An average value of these four detected values is taken as an amplitude detected value, and is regarded as a monitored value of a driver temperature. As another option, the maximum value of the four detected values can be taken, and can be regarded as a monitored value of a driver temperature to enable temperature detection which does not depend on a positional relation between the driver and an external temperature sensor in the case of using the external temperature sensor. Furthermore, for adaptation to a signal format such as BPSK, the driver 101 includes an output disabling function of blocking an output signal of each channel in each driver. In other words, in the present example embodiment, the drivers exist as the four channels, and in the case of QPSK, correspond to the respective channels. However, since BPSK concerns two channels, output of the two surplus channels is disabled. Although other control signals are output from the controller 5 to the driver 101, FIG. 2 illustrates only the output disabling function.

In order to disable output, for example, there is a method of blocking a drain voltage of the FET of the driver so that in an output disabled state, output amplitude detection is impossible, and heat generation of the driver does not occur. Operation for the disabling is made via the controller 5 from the host side. When driver output is disabled, the controller 5 invalidates the monitoring of a driver temperature based on amplitude detected values of the channels concerned, and calculates a monitored value of a driver temperature on the basis of amplitude detected values of the drivers of an enabled state. When all of the channels are disabled, the driver is not a heat source, a temperature is determined by the surrounding and other heating elements, and for this reason, the temperature sensor 601 is used for monitoring a temperature of the driver. An internal temperature difference between this temperature sensor 601 and the driver is measured in advance, and is recorded in the controller so that a temperature monitored value of the driver can be calculated. The directions of the arrows in FIG. 2 represent one example, and do not limit directions of signals between blocks.

When an input signal is disabled, although output amplitude is not generated, the driver itself generates heat since a drain voltage is applied to the FET of the driver. For this reason, it becomes difficult for the amplitude detection function to monitor a driver temperature. In this case, an amplitude detection range is regulated, and when a detected value of output amplitude is lower than a lower limit value, the controller 5 determines a state as a signal disabled one, and holds a monitored value of a driver temperature at the time of the latest reception of an input signal to thereby perform temperature monitoring and make notification to the host side.

In the present example embodiment, assumed operation is a limiting type in which output amplitude does not fluctuate in relation to input signal amplitude of the driver.

### Effect of Example Embodiment

In the present example embodiment, the incorporated controller uses the amplitude detection function incorporated in the transmission driver, detects a temperature property of the amplitude detection function caused by temperature dependency of the FET constituting the driver, and performs temperature monitoring of the driver. For this reason, a dedicated temperature sensor is unnecessary, a size of the optical transceiver can be reduced, and further, high accuracy can be attained.

### 3rd Example Embodiment

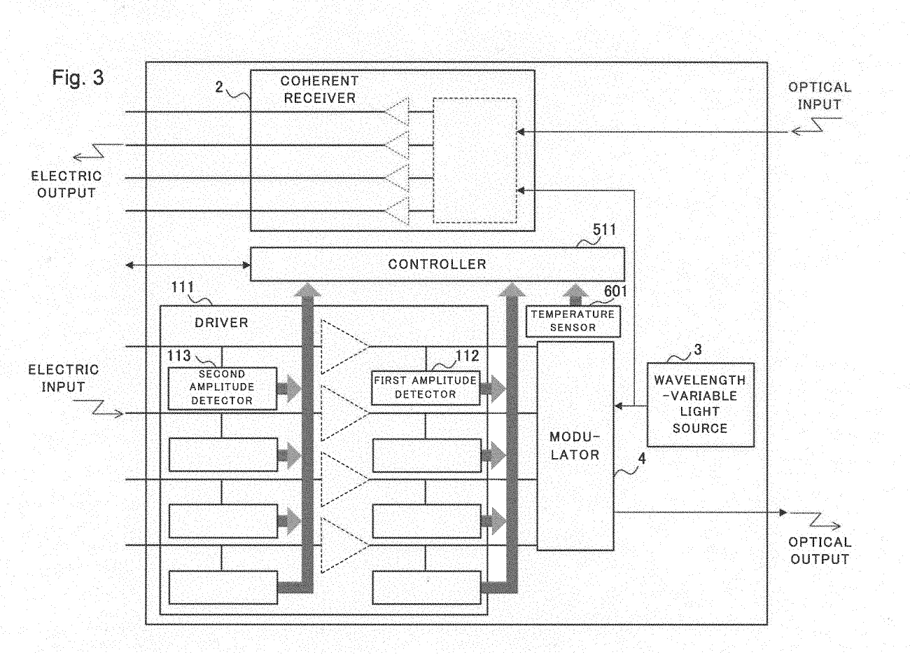

FIG. 3 is a block diagram illustrating a configuration of an optical transceiver according to a third example embodiment of the present invention. The present example embodiment is an example adapted to a linear type of driver in which output amplitude is output in a proportional relation with input signal amplitude. In the driver 111, a second amplitude detector 113 is mounted at a prior stage of an amplifier. A first amplitude detector 112 is mounted at a subsequent stage of the amplifier, and a controller 511 calculates a difference between an amplitude detected value of the first amplitude detector 112 and an amplitude detected value of the second amplitude detector 113 to thereby derive gain of the amplifier. A temperature property of this gain is similar to the first example embodiment, and the temperature property of the gain is calculated backward, and a temperature monitoring of the driver is performed.

### 4th Example Embodiment

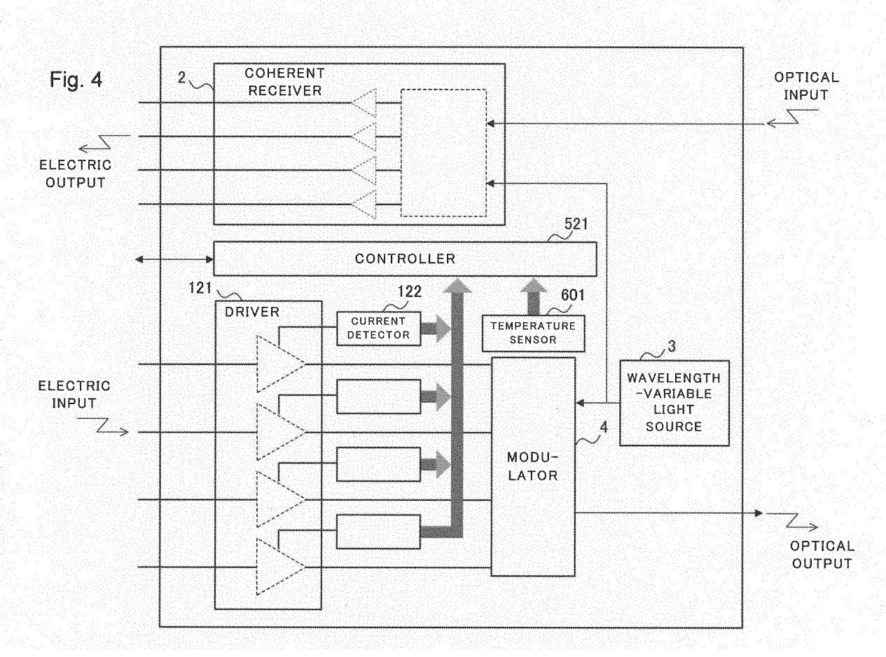

FIG. 4 is a diagram illustrating a configuration according to a fourth example embodiment of the present invention, and is an example in which a current detector 122 is arranged at a drain of an FET constituting a driver in a driver 121. The current detector 122 is concretely a current detection resistance. The current detector 122 monitors whether or not a bias current is within an appropriate range. In the present example embodiment, this function continues to be used without change.

As described above, trans conductance gm of the FET generally has a temperature property of lowering at a high temperature. Further, under a condition that a voltage between a gate and a source of the FET is constant, a threshold voltage Vt has a temperature property, and in addition, a drain current has a temperature property. Similarly to gain of the driver, the temperature property of a drain current is used so that a monitored value of a drain current is input to a controller 521, a temperature is calculated from the drain current, and a temperature monitoring of the driver is performed.

In the present example embodiment, a current value detection function originally incorporated in the transmission driver is used so that a temperature property of the current value detection function caused by temperature dependency of a drain current of the FET constituting the driver is detected, and the incorporated controller is used to perform temperature monitoring of the driver. For this reason, a dedicated temperature sensor is unnecessary, size reduction can be made, and further, high accuracy can be attained.

### 5th Example Embodiment

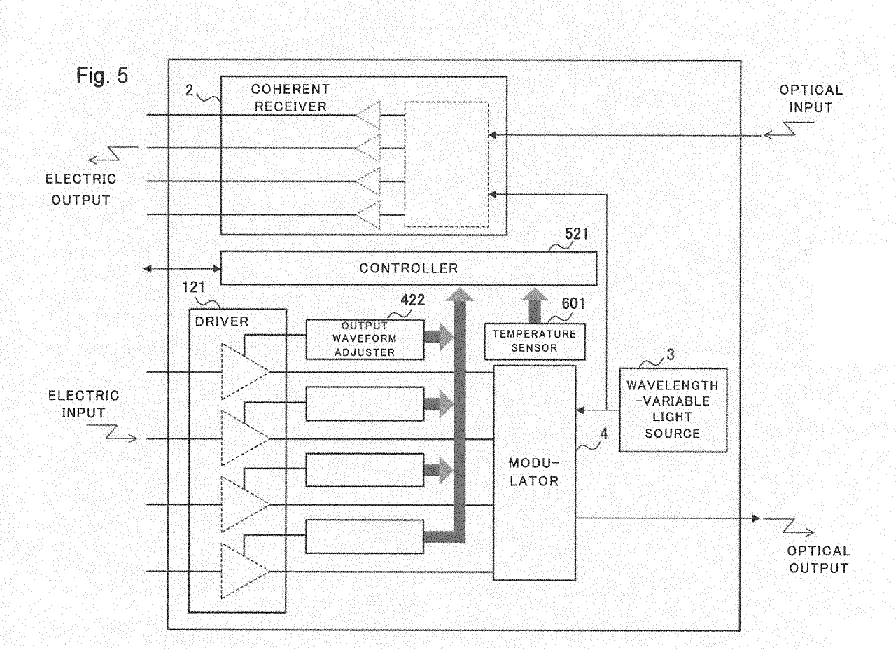

FIG. 5 is a diagram illustrating a configuration according to a fifth example embodiment of the present invention, and an output waveform adjuster 422 is arranged at a drain of the FET constituting the driver in the driver 121. The output waveform adjuster 422 includes a function of adjusting an output waveform having generated distortion or bluntness. An output waveform changes depending on a temperature. A relation between a waveform and a temperature are examined in advance, and similarly to the first to fourth example embodiments, a temperature is calculated from an output waveform to perform temperature monitoring of the driver. In the present example embodiment, a dedicated temperature sensor is unnecessary, size reduction can be made, and further, high accuracy can be attained.

The directions of the arrows in FIG. 3 to FIG. 5 represent one example, and do not limit directions of signals between blocks.

A part or all of the above-described example embodiments can be described as in the following supplementary notes without being limited to the following.

### (Supplementary Note 1)

An optical transmitter including at least one transmission driver, wherein a detection circuit detecting output fluctuation due to temperature dependency of the transmission driver is provided.

### (Supplementary Note 2)

The optical transmitter according to the supplementary note 1, wherein the detection circuit is an amplitude detector of the transmission driver.

### (Supplementary Note 3)

The optical transmitter according to the supplementary note 1, wherein the detection circuit is a current detector of the transmission driver.

### (Supplementary Note 4)

The optical transmitter according to the supplementary note 1, wherein the detection circuit is an output waveform adjuster of the transmission driver.

### (Supplementary Note 5)

The optical transmitter according to any one of the supplementary notes 1 to 4, further including a controller, wherein the controller converts output of the detection circuit into a temperature of the transmission driver.

### (Supplementary Note 6)

The optical transmitter according to the supplementary note 5, wherein approximation of a polynomial whose variable is a temperature is used in conversion of output of the amplitude detector into a temperature.

### (Supplementary Note 7)

The optical transmitter according to any one of the supplementary notes 1 to 6, wherein when a plurality of the transmission drivers exist, an average value of detected values of the detection circuits provided for the respective transmission drivers is regarded as a temperature of the plurality of drivers.

### (Supplementary Note 8)

The optical transmitter according to any one of the supplementary notes 5 to 7, wherein an amplitude detection range is set in the controller so that when a detected value of the amplitude detector is lower than a lower limit of the range, it is determined that an input signal to the transmission driver does not exist, and temperature data of the driver at the time of the latest reception of an input signal is held.

### (Supplementary Note 9)

The optical transmitter according to any one of the supplementary notes 1 to 8, wherein the transmission driver performs a limiting type of operation in which output amplitude does not fluctuate in relation to amplitude of an input signal.

### (Supplementary Note 10)

The optical transmitter according to any one of the supplementary notes 2 to 9, wherein a first amplitude detector is provided at a prior stage of the transmission driver, a second amplitude detector is provided at a subsequent stage of the transmission driver, and a difference between detected values of the first and second amplitude detectors is taken to derive gain of the driver.

### (Supplementary Note 11)

The optical transmitter according to any one of the supplementary notes 1 to 10, further including a wavelength-variable light source and a modulator, wherein the modulator modulates output of the wavelength-variable light source by output of the transmission driver to perform optical output.

### (Supplementary Note 12)

An optical transceiver wherein a receiver receiving optical input is added to the optical transmitter according to any one of the supplementary notes 1 to 11.

In the above, the above-described example embodiments are cited as model examples to describe the present invention. The present invention is however not limited to the above-described example embodiments. In other words, in the present invention, various configurations that can be understood by a person skilled in the art can be applied within the scope of the present invention.

The present application claims priority based on Japanese patent application No. 2014-206950 filed on Oct. 8, 2014, of which entire disclosure is incorporated herein.

### INDUSTRIAL APPLICABILITY

The present invention can be used in a CFP2 optical transceiver, a small long-range coherent transceiver, or the like.

### REFERENCE SIGNS LIST

41, 100, 101, 121 Driver
2 Coherent receiver
3 Wavelength-variable light source
30 Light source
4, 40 Modulator
5, 50, 511 Controller
46, 601 Temperature sensor
102 Amplitude detector
112 First amplitude detector
113 Second amplitude detector
122 Current detector
200 Detector
422 Output waveform adjuster

1. An optical transmitter comprising at least one transmission driver, wherein a detection circuit that detects output fluctuation due to temperature dependency of the transmission driver is provided.

2. The optical transmitter according to claim 1, wherein the detection circuit is an amplitude detector of the transmission driver.

3. The optical transmitter according to claim 1, wherein the detection circuit is a current detector of the transmission driver.

4. The optical transmitter according to claim 1, wherein the detection circuit is an output waveform adjuster of the transmission driver.

5. The optical transmitter according to claim 1, further comprising a controller, wherein the controller converts output of the detection circuit into a temperature of the transmission driver.

6. The optical transmitter according to claim 5, wherein approximation of a polynomial whose variable is a temperature is used in conversion of output of the amplitude detector into a temperature data.

7. The optical transmitter according to claim 1, wherein, when a plurality of the transmission drivers exist, an average value of detected values of the detection circuits provided for the respective transmission drivers is regarded as a temperature of the plurality of drivers.

8. The optical transmitter according to claim 5, wherein an amplitude detection range is set in the controller so that when a detected value of the amplitude detector is lower than a lower limit of the range, it is determined that an input signal to the transmission driver does not exist, and temperature data of the driver at a time of latest reception of an input signal are held.

9. The optical transmitter according to claim 2, wherein a first amplitude detector is provided at a prior stage of the transmission driver, a second amplitude detector is provided at a subsequent stage of the transmission driver, and a difference between detected values of the first and second amplitude detectors is taken to derive gain of the driver.

10. An optical transceiver comprising a receiver that receives optical input, in addition to the optical transmitter according to claim 1.

11. The optical transmitter according to claim 1, wherein the transmission driver performs a limiting type of operation in which output amplitude does not fluctuate in relation to amplitude of an input signal.

12. The optical transmitter according to claim 1, further including a wavelength-variable light source and a modulator, wherein the modulator modulates output of the wavelength-variable light source by output of the transmission driver to perform optical output.
